(19) United States
(12) Patent Application Publication
(10) Pub. No.: US 2026/0350437 A1
(43) Pub. Date: Nov. 5, 2026

(54) AI-DigiScore™: System and Method for Runtime Trust Enforcement, Agentic Appraisal, Drift Prediction, Cross-Model Continuity, and Blockchain-Anchored Governance of AI-Generated Content

(71) Applicant: Patrick Joseph Hopper, Dallas, TX (US)

(72) Inventor: Patrick Joseph Hopper, Dallas, TX (US)

(21) Appl. No.: 19/653,041

(22) Filed: Apr. 20, 2026

Related U.S. Application Data
(60) Provisional application No. 63/791,657, filed on Apr. 20, 2025.
(60) Provisional application No. 63/847,461, filed on Jul. 20, 2025.

(51) Int. Cl. G06N 5/04

(52) U.S. Cl. CPC G06N 5/04

(57) ABSTRACT

A computer-implemented trust-enforcement system governs Al-generated content evaluating an output from one or more artificial intelligence models or agents using a pre-logic validator, continuity engine, reflexive integrity engine, and an exception routing engine. The system assigns a trust value, enforces a trust ceiling absent human approval, and creates a point-in-time snapshot record that controls downstream release and reliance. Trust continuity across model handoffs is preserved using trust packets and trust-delta comparisons. Agent performance is appraised using planning-depth, goal-persistence, and coherence-similarity metrics, with decay referenced to a T50 horizon. Long-form degradation may trigger segmentation, rescoring, labeling, suppression, or escalation. In some embodiments, semantic integrity is enforced by detecting semantically sensitive phrase spans, generating cryptographic digests, comparing the digests with a trusted-hash registry, and downgrading, quarantining, suppressing, or escalating unmatched outputs. A meta-integrity digest may be anchored to a tamper-evident ledger for audit.

### CROSS-REFERENCE TO RELATED APPLICATIONS

This application claims the benefit of U.S. Provisional Patent Application No. 63/791,657, filed Apr. 20, 2025, and U.S. Provisional Patent Application No. 63/847,461, filed Jul. 20, 2025. The entire disclosures of those applications are incorporated herein by reference to the extent permitted by law.

This application relates to subject matter including modular trust scoring, trust-ceiling enforcement, snapshot locking, exception routing, continuity validation, reflexive integrity auditing, agent appraisal, cross-model trust transfer, decay prediction, semantic integrity protection, and blockchain-anchored governance of AI-generated content.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE

The entire disclosures of U.S. Provisional Patent Application No. 63/791,657, filed Apr. 20, 2025, and U.S. Provisional Patent Application No. 63/847,461, filed Jul. 20, 2025, are incorporated herein by reference to the extent permitted by law and to the extent not inconsistent with the present specification.

### STATEMENT REGARDING PRIOR DISCLOSURES BY THE INVENTOR OR A JOINT INVENTOR

To the extent any disclosure of subject matter described herein was made by the inventor or a joint inventor, or by another who obtained the subject matter directly or indirectly from the inventor or a joint inventor, within one year prior to the effective filing date of the claimed invention, applicant relies on any applicable exception under 35 U.S.C. § 102(b)(1) and reserves all rights associated therewith.

### FIELD OF THE INVENTION

The present invention provides a computer-implemented system and method for assigning, enforcing, preserving, and governing earned trust in AI-generated content. The invention operates as a runtime trust-enforcement architecture that evaluates outputs produced by one or more artificial intelligence models, multimodal systems, autonomous agents, or model-to-model handoffs

### BACKGROUND OF THE INVENTION

The present invention provides a computer-implemented system and method for assigning, enforcing, preserving, and governing earned trust in AI-generated content. The invention operates as a runtime trust-enforcement architecture that evaluates outputs produced by one or more artificial intelligence models, multimodal systems, autonomous agents, or model-to-model handoffs

### SUMMARY OF THE INVENTION

The present invention provides a computer-implemented system and method for assigning, enforcing, preserving, and governing earned trust in AI-generated content. The invention operates as a runtime trust-enforcement architecture that evaluates outputs produced by one or more artificial intelligence models, multimodal systems, autonomous agents, or model-to-model handoffs, and determines whether such outputs may be relied upon, downgraded, segmented, suppressed, escalated for review, or exported to downstream users or systems.

In one aspect, the invention rejects the assumption that fluent AI output is inherently reliable. Instead, the invention evaluates output trustworthiness based on structural integrity, contextual continuity, semantic fidelity, exception behavior, auditability, and governance conditions. A trust value is computed for each output or output segment and is stored together with validation state, module activation state, and audit metadata so that trust is treated as an earned, point-in-time condition rather than a permanent attribute.

In one embodiment, the invention includes a modular scoring framework comprising a Trust Pyramid evaluator, a Pre-Logic validation gate, a Continuity Engine, a Reflexive Integrity Layer, an Exception Layer, and a Snapshot Lock. The Trust Pyramid evaluator applies a bounded trust scale and, in preferred embodiments, enforces a trust ceiling for AI-only outputs unless a human-in-the-loop approval is recorded. The Pre-Logic validation gate verifies that required glossary, context, module, or policy conditions are satisfied before an output may be elevated. The Continuity Engine detects stale context, hallucinated carry-over, recycled logic, and memory drift across turns or sessions. The Reflexive Integrity Layer audits the scoring process itself for narrative dominance, self-reinforcing logic, unjustified confidence, or structurally unsupported conclusions. The Exception Layer captures anomalies, ambiguity, or validation failures and routes such outputs into downgrade, quarantine, revalidation, or human-review pathways. The Snapshot Lock preserves the trust state, model version, validation result, and related metadata in an audit-ready record that may be replayed or verified later.

In another aspect, the invention implements an uncertainty-biased governance policy derived from repeated failures observed in fragmented, high-risk, or under-documented operating environments. This policy, referred to herein as the Expat Mindset, causes the system to elevate exceptions over averages, resist premature consensus, flag missing or contradictory context, and require additional validation when the system encounters unstable, low-confidence, stale, contradictory, or poorly documented information. In preferred embodiments, this governance policy affects downgrade thresholds, exception routing, freshness scoring, context resets, and human-review triggers.

In another embodiment, the invention packages trust-state information into a compact machine-readable structure, referred to in some implementations as a Semantic Trust Packet, containing at least a trust value, a ceiling flag, a module activation map, and a cryptographic digest. The Semantic Trust Packet may be passed between modules, between models, between agent nodes, or between runtime and audit layers so that trust continuity can be maintained and verified across a workflow.

In another aspect, the invention includes an agent-appraisal subsystem configured to evaluate a plurality of autonomous or semi-autonomous AI agents. For each agent, the subsystem may compute a planning-depth metric, a goal-persistence metric, and a coherence-similarity metric, combine such metrics into a raw performance score, apply a decay factor tied to a task-specific T50 horizon, normalize the resulting score on a bell-curve distribution, and downgrade agents that fall below a drift threshold. The subsystem may further downgrade a composite orchestration score when a threshold percentage of agents exhibit pseudo-agentic drift, and may route such conditions to human review.

In another embodiment, the invention maintains trust continuity across heterogeneous models by generating trust-state records before and after a model handoff, computing a trust delta between the records, and downgrading, flagging, segmenting, disclaiming, or suppressing outputs when the delta exceeds one or more thresholds. The invention further predicts long-form reliability decay by modeling trust slope against token length and generating an early-warning event when the slope becomes negative near a T50 horizon. In response, remaining output may be segmented into smaller units for rescoring, reduced in length, annotated, or blocked from export.

In another aspect, the invention includes a semantic-integrity enforcement subsystem configured to detect and protect against semantic reversals, including but not limited to negation inversion. In preferred embodiments, the subsystem detects a negation phrase or other semantically sensitive phrase, normalizes a contextually relevant span, generates a cryptographic hash, and compares the hash against a Trusted-Hash Registry of approved constructs. Upon mismatch or ambiguity, the subsystem may downgrade trust, label the output, quarantine or suppress the output, escalate the output for human review, or anchor the event to an audit record. In some embodiments, the subsystem further includes a Glossary Lock, a Context Locking Q&A engine, runtime semantic drift checks, and export suppression controls, thereby ensuring that denials, exclusions, refusals, and other critical semantic boundaries remain preserved across multi-turn, long-form, or cross-model workflows.

In another embodiment, the invention includes an Immutable Function Registry or comparable audit-anchoring layer that generates a meta-integrity digest from trust-state data, module execution state, ceiling flags, trust slope, nonce values, or related governance metadata. The digest may be written to a permissioned blockchain, decentralized knowledge graph, or other tamper-evident ledger. In some implementations, the system generates a transaction hash, QR-linked verification record, or zero-knowledge proof to support downstream verification without exposing sensitive prompt or output content. Policy engines may use the anchored record to enforce risk-tier-specific suppression, fiduciary alignment checks, override logging, regulator-facing replay, or board-level review.

In another aspect, the invention includes auxiliary governance hooks that further modulate trust. Such hooks may include trust-efficiency toggles that cap trust when certain checks are bypassed, skeptic-oriented prompt injection modules that require supporting evidence or counter-arguments, variance validators that penalize unstable ensemble behavior, memory-compression or confidence-drift monitors that detect repetitive or inflationary output patterns, and data-gap heuristics that reduce trust when a response depends on under-documented regions, sparse records, or emerging-market uncertainty indicators.

The invention may be deployed inline, in shadow mode, or as a standalone audit layer. It may operate as middleware, a microservice, an on-premise module, a cloud-native service, an edge cache, or a hybrid architecture spanning local runtime systems and remote audit infrastructure. The invention may be applied to public, enterprise, sovereign, regulated, confidential, or high-risk environments, including but not limited to healthcare, legal, finance, compliance, public sector, defense, education, and agentic orchestration systems.

Accordingly, the invention transforms AI governance from passive description into active enforcement by combining runtime trust scoring, semantic validation, continuity protection, exception routing, agent appraisal, cross-model trust transfer, decay prediction, and immutable audit preservation within a unified framework. The result is a system in which trust is neither presumed nor static, but earned, bounded, traceable, and reviewable before downstream reliance is permitted.

### 7. BRIEF DESCRIPTION OF THE DRAWINGS

The accompanying drawings illustrate representative embodiments of the invention and are provided to explain, and not to limit, the claimed subject matter. The drawings are schematic in nature and are not necessarily to scale. Like reference numerals, where used, identify like or corresponding elements throughout the several views.

FIG. 1 is a schematic diagram of a unified AI-DigiScore runtime governance architecture showing an Inference Layer 100, a Core Trust Layer 200, an Extensions Layer 300, and a Governance Layer 400, together with trust-flow routing between generation, scoring, downgrade, escalation, snapshot preservation, and release control.

FIG. 2 is a diagram of a Trust Pyramid and trust-ceiling structure illustrating multiple earned-trust levels and a bounded trust state for AI-only outputs unless elevated through human review.

FIG. 3 is a diagram of a Continuity Engine with memory anchors, freshness clocks, prompt lineage tracking, and continuity revalidation logic.

FIG. 4 is a flow diagram of an Exception Layer configured to identify incomplete, ambiguous, conflicting, or structurally unsupported outputs and route such outputs into downgrade, quarantine, delayed revalidation, or human-review pathways.

FIG. 5 is an exploded view of a Reflexive Integrity Layer showing Perspective Deviation Score, Narrative Dominance Index, and Self-Referencing Bias Detector submodules in an auto-calibration loop.

FIG. 6 is a Pre Logic validation path illustrating gatekeeping checks including completeness, logical progression, glossary alignment, and scoring preconditions before assignment of a base earned-trust score.

FIG. 7 is a deployment-mode diagram illustrating Inline, Shadow, and Standalone/Audit operating configurations.

FIG. 8 is an export-chain diagram showing scored content appended with metadata including version tag, scoring configuration hash, active module registry, human-vetting log, and snapshot-linked release state.

FIG. 9 is an hourglass trust-flow diagram illustrating AI-generated content passing through a narrowing trust funnel with recursive scoring, reflexive modulation, and layered trust accumulation before final elevation or reassessment.

FIG. 10 is a dashboard view of an Agent-Performance Scoring Module 310 in which a plurality of AI agents are normalized on a bell-curve distribution based on planning depth, goal persistence, and coherence similarity, with drift thresholds for downgrade or escalation.

FIG. 11 is a Cross-Model Echo-Loop flow diagram showing pre-handoff and post-handoff trust packets, trust-delta calculation, downgrade or suppression paths, and Echo-Loop logging.

FIG. 12 is a T50 decay prediction graph illustrating trust degradation as a function of token count or generation progression and showing an early-warning threshold for segmentation, disclaimer insertion, downgrade, or suppression.

FIG. 13 is an Immutable Function Registry anchor flow showing generation of a meta-integrity digest, anchoring of the digest to a permissioned blockchain, QR-linked verification, optional zero-knowledge proof generation, and policy-based routing or override functions.

FIG. 14 is a Negation Firewall system architecture diagram illustrating an Input Scan Module 601, a Hashing Engine 602, a Trusted-Hash Registry 603, a Trust Scoring Engine 604, a Mitigation Layer 605, a Snapshot Lock Module 606, and an optional Blockchain or DKG Anchor 607.

FIG. 15 is a negation-phrase or semantic-validation sequence flow illustrating input receipt, phrase-span selection, canonicalization, hash generation, registry lookup, validation-success routing, and validation-failure mitigation including downgrade, quarantine, suppression, or human escalation.

FIG. 16 is a trusted-hash registry schema showing storage of phrase digests, canonical phrase forms, domain context, metadata, and audit trail logs for semantic-integrity validation.

FIG. 17 is a scalable trusted-hash registry topology showing an Edge Bloom Filter 701, an in-memory Redis/SQLite layer 702, and a global DynamoDB/DKG anchor 703 for low-latency validation and audit preservation.

### 8. DETAILED DESCRIPTION OF THE INVENTION

The present invention may be embodied in various forms and implemented in hardware, software, firmware, model policy, workflow logic, or any combination thereof. The following description is provided to enable a person of ordinary skill in the art to make and use the invention and is not intended to limit the scope of the claimed subject matter. Unless otherwise stated, references to “AI,” “model,” “system,” “engine,” “module,” or “agent” may refer to one or more language models, multimodal models, tool-using systems, autonomous agents, orchestration frameworks, rule-based components, or human-supervised pipelines.

### 8.1 Overview and Operational Philosophy

The invention provides a runtime trust-enforcement architecture for AI-generated content. In contrast to systems that treat fluency, responsiveness, or apparent coherence as proxies for reliability, the present invention evaluates whether trust has been earned through structure, continuity, semantic fidelity, exception handling, and governance review. The invention therefore treats trust as a bounded, auditable state associated with a particular output at a particular time, rather than as a permanent or model-wide characteristic.

In preferred embodiments, the invention is informed by an operational control philosophy referred to herein as the Expat Mindset. As implemented in the present system, the Expat Mindset is not merely narrative context, but a set of machine-enforceable governance heuristics developed in response to high-uncertainty, fragmented, contradictory, or under-documented environments. Such heuristics cause the system to elevate exception signals over averages, to treat missing or stale context as a material risk factor, to resist premature consensus, and to require additional validation before an output can be elevated beyond a bounded trust state. In this way, the system is configured to fail safely, escalate wisely, and preserve decision traceability even where the input environment is unstable.

The invention is designed to address several recurring AI failure classes, including semantic reversals, negation inversion, hallucinated continuity, overconfident but structurally unsupported outputs, cross-model handoff loss, long-form trust decay, pseudo-agentic drift, audit gaps, memory compression artifacts, and unreviewed export into downstream business or regulatory processes.

### 8.2 System Architecture

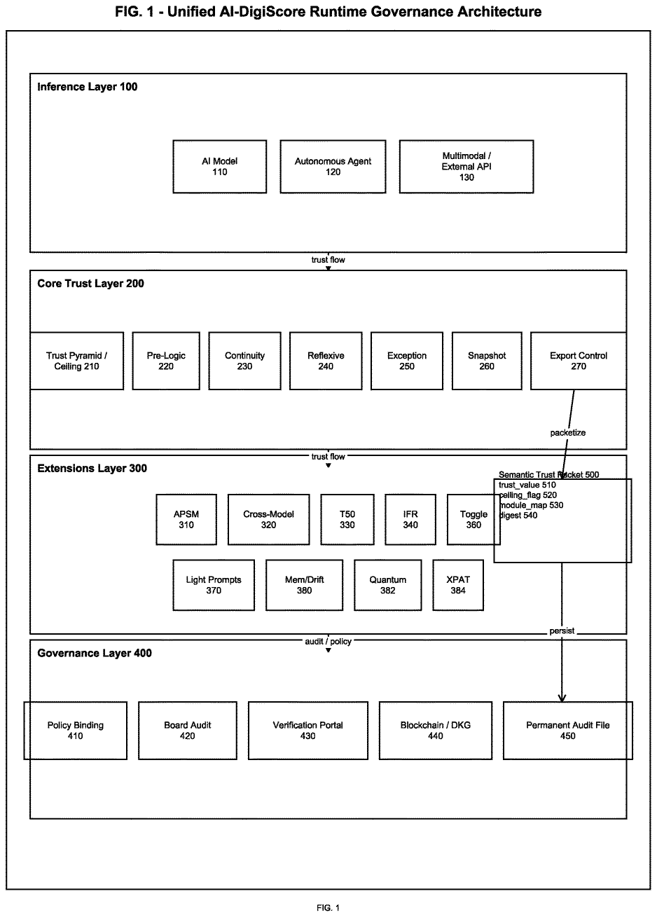

Referring to FIG. 1, the system may be organized into four cooperating layers. An Inference Layer 100 includes one or more AI models or agents, such as a model engine 110, an autonomous or tool-using agent 120, or a multimodal or external API component 130. A Core Trust Layer 200 includes a Trust Pyramid/Trust-Ceiling Evaluator 210, a Pre-Logic Validator 220, a Continuity Engine 230, a Reflexive Integrity Layer 240, an Exception Layer 250, a Snapshot Lock 260, and an Export-Control Engine 270. An Extensions Layer 300 may include an APSM 310, a Cross-Model Trust-Transfer Module 320, a T50 Decay Prediction Module 330, an IFR Module 340, a Trust-Efficiency Toggle 360, a Light Prompts Module 370, a Memory-Compression/Confidence-Drift Monitor 380, a Quantum-Variance Validator 382, and an XPAT Heuristic Module 384. A Governance Layer 400 may include a Policy-Binding Engine 410, a Board-Audit Dashboard 420, a Regulator or Verification Portal 430, a Blockchain/DKG Node 440, and a Permanent Audit File 450.

Input data to the system may include prompts, model responses, system instructions, citations, source documents, structured datasets, sensor-derived data, contractual records, API outputs, conversation history, tool traces, user profiles, expertise scores, or previous trust-state records. Output data from the system may include scored content, downgraded content, annotations, warnings, review tasks, trust packets, hash-locked records, export metadata, or suppress-and-hold decisions.

The modules of the system may be deployed as a monolithic application, a service-oriented architecture, a microservice pipeline, embedded middleware, a plug-in, a browser-based governance layer, an on-premise appliance, a sovereign environment, or an edge runtime. Modules may be activated individually or in sets based on policy, customer needs, sector risk, or computational constraints.

### 8.3 Semantic Trust Packet and Trust-State Data

In preferred embodiments, the system represents runtime trust using a machine-readable data structure referred to herein as a Semantic Trust Packet. The Semantic Trust Packet may include a current trust value, a ceiling flag, a module map, a cryptographic digest, a model identifier, a timestamp, a risk-tier designation, a downgrade code, a human-review status, a source lineage identifier, or any combination thereof. In one embodiment, the module map is represented as a bit mask indicating which validation or audit modules executed for a given output. In another embodiment, the packet includes a policy profile identifier, such as a medical, legal, financial, education, or ultra-skeptic profile.

The Semantic Trust Packet may be created at generation time, updated during validation, transferred across models or agents, recorded in snapshot storage, or anchored to an immutable registry. By using a shared trust-state object, the system preserves continuity across otherwise disconnected runtime stages and provides a common basis for downgrade, escalation, suppression, or verification.

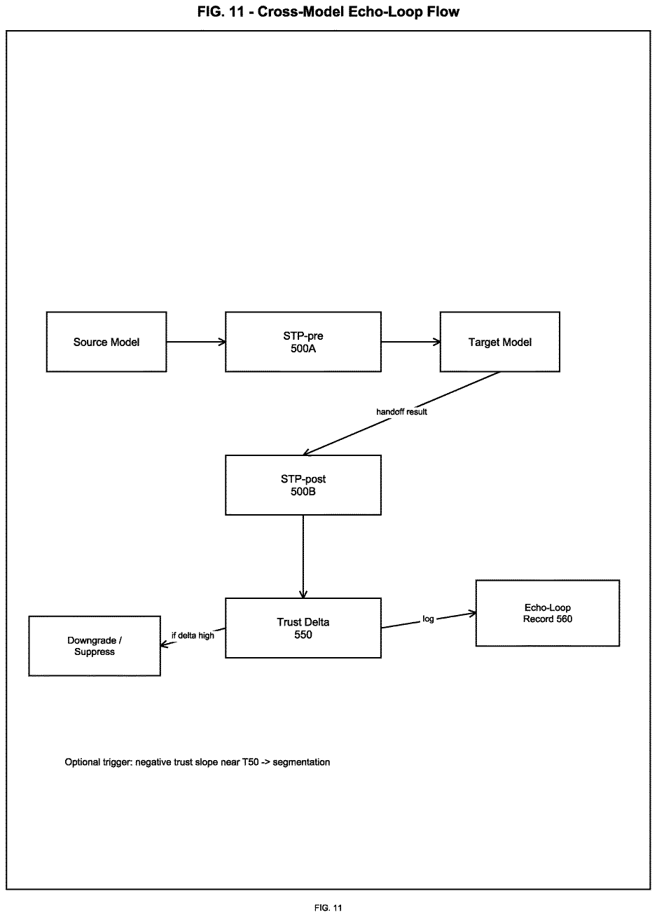

As shown in FIG. 11, a Semantic Trust Packet 500 may include a Trust Value Field 510, a Ceiling Flag 520, a Module-Activation Map 530, and a Digest Field 540. A computed Trust Delta 550 may be stored in an Echo-Loop Record 560 and linked to a Snapshot Record 570 or a Meta-Integrity Digest 580.

### 8.4 Trust Pyramid and Trust-Ceiling Enforcement

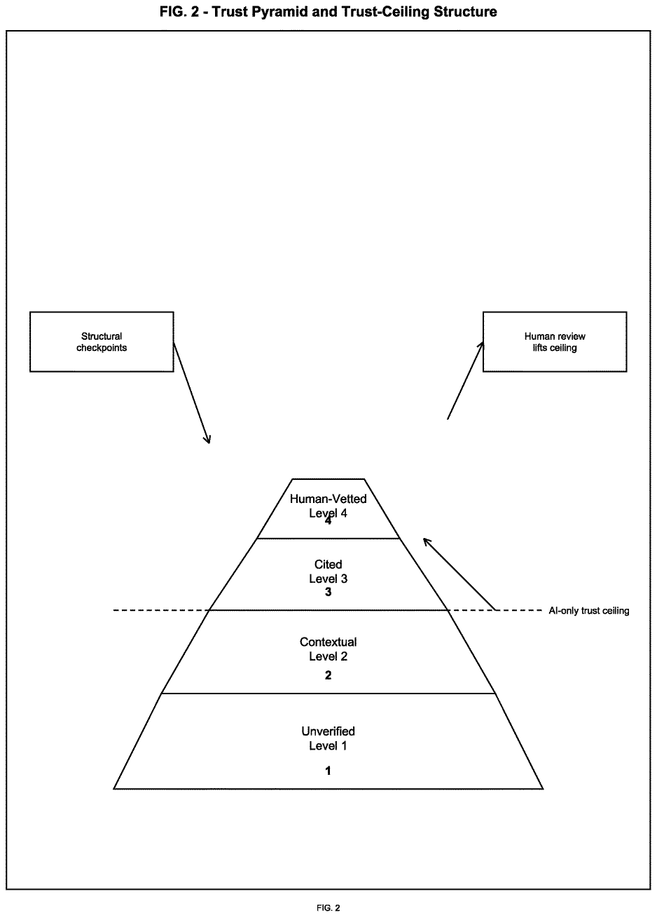

Referring to FIG. 2, the invention may employ a bounded trust scale, such as a numerical range from 0.0 to 10.0, although other scales may be used. In preferred embodiments, AI-only outputs are prevented from exceeding a configurable ceiling unless an authorized human reviewer, verifier, or other trusted authority has elevated the result. In one preferred embodiment, the ceiling is 7.0 for AI-only outputs. In high-risk contexts, the ceiling may be lower. In some efficiency-oriented modes, the ceiling may be reduced further, such as to 6.5 or another configurable maximum.

A trust value may be determined using any suitable scoring function. In one embodiment, the trust value is a function of provenance, freshness, semantic integrity, continuity, exception load, reflexive audit outcome, user expertise, risk tier, and human-review state. In another embodiment, the trust value is determined through additive or subtractive weighting, with negative adjustments for ambiguity, unsupported claims, stale data, narrative dominance, semantic drift, or failed policy checks. In another embodiment, the trust value may be discretized into trust bands or categories rather than a continuous number.

The Trust Pyramid may classify outputs into multiple levels of earned trust, ranging from speculative or low-support content at lower levels to human-verified or multi-source-confirmed content at higher levels. A trust ceiling prevents a system from implying confidence that has not been earned through required review conditions. This ceiling is especially useful in regulated contexts, where an output that appears polished but lacks structural support must not be represented as fully trustworthy.

Referring to FIG. 2, the Trust Pyramid 210 may include multiple trust levels arranged from unverified output at a lower level to human-vetted output at an upper level, with a ceiling applied to AI-only outputs.

### 8.5 Pre-Logic Validation Gate

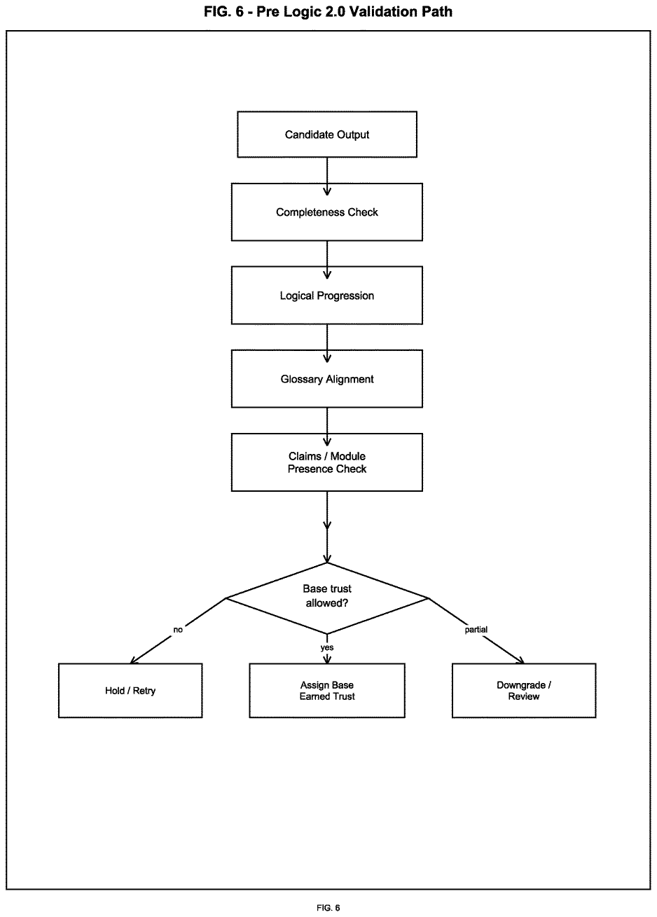

Referring to FIG. 6, the invention may include a Pre-Logic validation gate that executes before trust elevation, export, or downstream use. The Pre-Logic gate may determine whether baseline structural requirements are satisfied before the system even attempts to assign or elevate trust. In preferred embodiments, the Pre-Logic gate checks for required fields, missing dependencies, glossary alignment, locked phrases, policy prerequisites, module activation state, and omission risk.

In some embodiments, a Pre Logic 2.0 implementation is used. Pre Logic 2.0 may include a locked-phrase registry, an omission watchdog, and dependency validation. The locked-phrase registry may store semantically critical phrases or clauses that must appear, must not be altered, or must be preserved in specific forms. The omission watchdog may identify whether a required caution, limitation, disclaimer, denial, citation pointer, or material condition is absent. Dependency validation may ensure that a trust score is not elevated when prerequisite modules, such as continuity checking or semantic-integrity checking, have not executed.

If the Pre-Logic gate fails, the system may cap trust, prevent scoring elevation, add a warning label, queue the output for review, force a retry, or suppress export entirely. In this manner, the Pre-Logic gate acts as a structural threshold that prevents polished but incomplete content from being misrepresented as review-ready.

Referring to FIG. 6, the Pre-Logic Validator 220 executes a gatekeeping path that checks completeness, logical progression, glossary alignment, and scoring prerequisites before assignment or elevation of trust.

### 8.6 Continuity Engine and Memory Governance

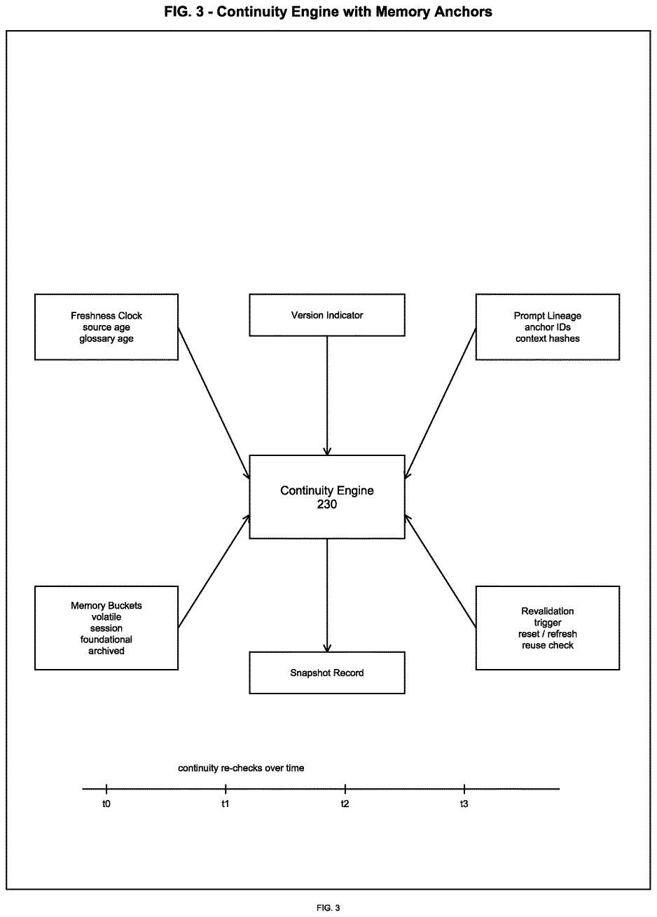

Referring to FIG. 3, the Continuity Engine manages temporal and contextual integrity across generations. The Continuity Engine may track source freshness, session boundaries, context lineage, prompt ancestry, glossary state, prior exceptions, and memory carry-over. It may detect when content appears consistent only because stale or recycled logic has been reused, when a prior session's trust state is inappropriately implied in a later session, or when a downgraded output has been silently reintroduced without revalidation.

In some embodiments, the Continuity Engine organizes memory into multiple buckets, including volatile memory, session memory, foundational memory, legacy memory, and archived memory. Different validation or decay rules may apply to each bucket. For example, session memory may expire quickly, foundational memory may require explicit governance approval to modify, and archived memory may be replayable but not automatically trusted.

The Continuity Engine may also implement a Freshness Audit Pacer, Dormant Exception Reminder, Memory Compression Signal, or Loopback Logic. The Freshness Audit Pacer may force periodic revalidation when a time threshold or interaction threshold is exceeded. The Dormant Exception Reminder may resurface unresolved exceptions that have not been reviewed. The Memory Compression Signal may detect repeated compression or abstraction that removes material nuance. Loopback Logic may force the system to re-audit content that reappears in revised form after having failed prior structural checks.

When continuity failure is detected, the engine may reduce trust, force a context reset, require a new snapshot lock, or route the output to an Exception Layer or human reviewer. Referring to FIG. 3, the Continuity Engine 230 maintains freshness clocks, anchor identifiers, and prompt lineage records for later continuity revalidation.

### 8.7 Reflexive Integrity Layer and Skeptic Audit Profiles

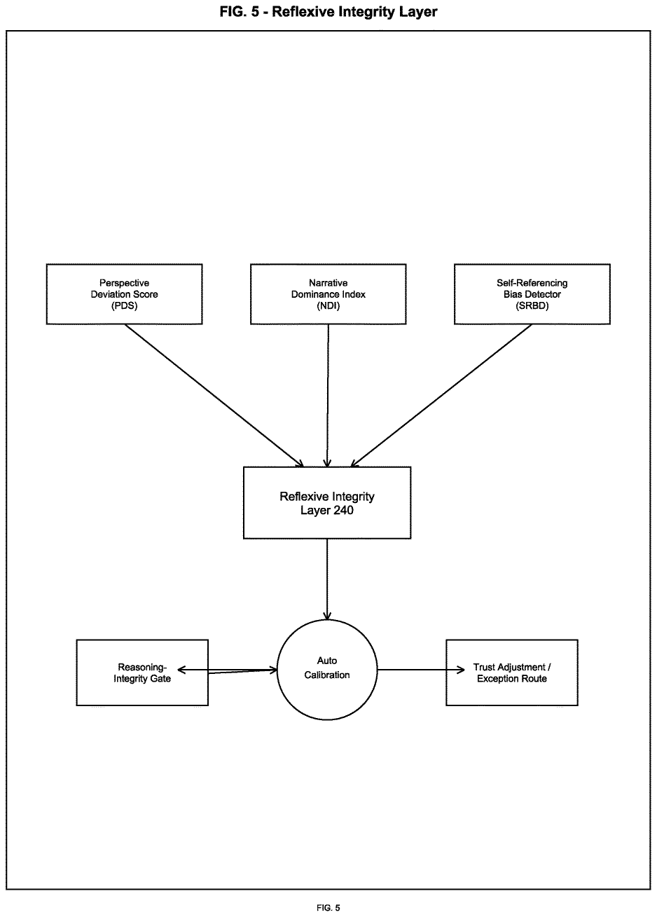

Referring to FIG. 5, the Reflexive Integrity Layer performs an audit of the trust-enforcement process itself. This layer is designed to detect whether the system is overstating its own confidence, reinforcing its own assumptions, or using structurally hollow reasoning to justify a trust score. In some embodiments, the layer computes one or more derived metrics, such as a Perspective Deviation Score, a Narrative Dominance Index, and a Self-Referencing Bias Detector.

The Perspective Deviation Score may measure whether alternative explanations, minority signals, contradictory facts, or unresolved caveats have been ignored. The Narrative Dominance Index may measure whether a single frame or explanation has crowded out uncertainty or competing evidence. The Self-Referencing Bias Detector may determine whether the system is using prior internal outputs, prior scores, or recursive logic as a substitute for actual support.

The Reflexive Integrity Layer may operate under selectable skepticism profiles. In some embodiments, such profiles include a standard review profile, a skeptic profile, an ultra-skeptic profile, a 901 audit profile, or a Skeptic Mode 905 profile. A higher-skepticism profile may increase downgrade weights, require more module coverage, force explicit explanation of missing evidence, or lower elevation thresholds. In some embodiments, the Reflexive Integrity Layer participates in an Infinity Loop Trust Flow, in which failed or ambiguous outputs are not permanently discarded but may re-enter the system only after structural correction, re-scoring, and creation of a new trust snapshot.

Referring to FIG. 5, the Reflexive Integrity Layer 240 includes a Perspective Deviation Score, a Narrative Dominance Index, and a Self-Referencing Bias Detector arranged in a reflexive scoring loop.

### 8.8 Exception Layer and Contextual Enforcement

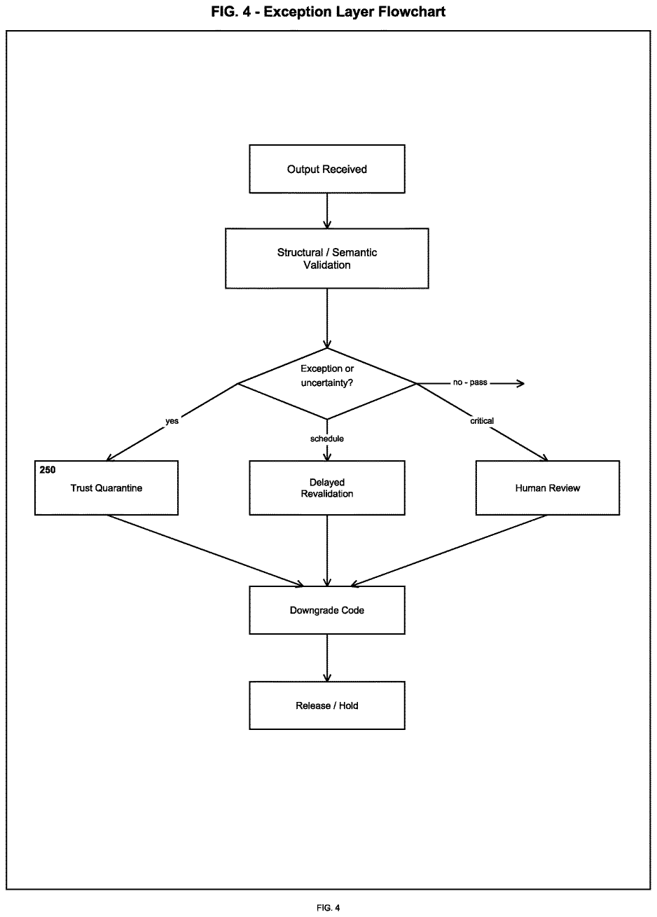

Referring to FIG. 4, the Exception Layer captures outputs that are incomplete, ambiguous, conflicting, semantically unstable, or unsupported despite sounding complete. In some embodiments, such outputs are classified as a Black Hole condition, meaning the response appears fluent or final while lacking traceable structure sufficient to justify its confidence. The Exception Layer may assign downgrade codes, create exception tickets, route the content into quarantine, or place the output into a staged review queue.

A Contextual Enforcement Layer may operate together with the Exception Layer to manage borderline trust states. In one embodiment, the Contextual Enforcement Layer governs outputs that fall in an intermediate range, such as approximately 7.0 to 8.0 on a 10-point scale, where the output is stronger than ordinary AI-only content but not yet entitled to full elevation. The Contextual Enforcement Layer may require additional evidence, counterfactual review, semantic lock confirmation, or human acknowledgement before such outputs can move upward. If these additional conditions are not met, the system may downgrade the output to a lower range, such as below 6.0, or route it for review.

The Exception Layer may further schedule later re-audits, including time-based re-review events, particularly where supporting data is expected to change or where unresolved ambiguity remains material.

Referring to FIG. 4, the Exception Layer 250 receives outputs that fail structural or semantic checks and routes such outputs into quarantine, delayed revalidation, downgrade, or human-review states.

### 8.9 Snapshot Lock, Permanent Audit File, and Export Control

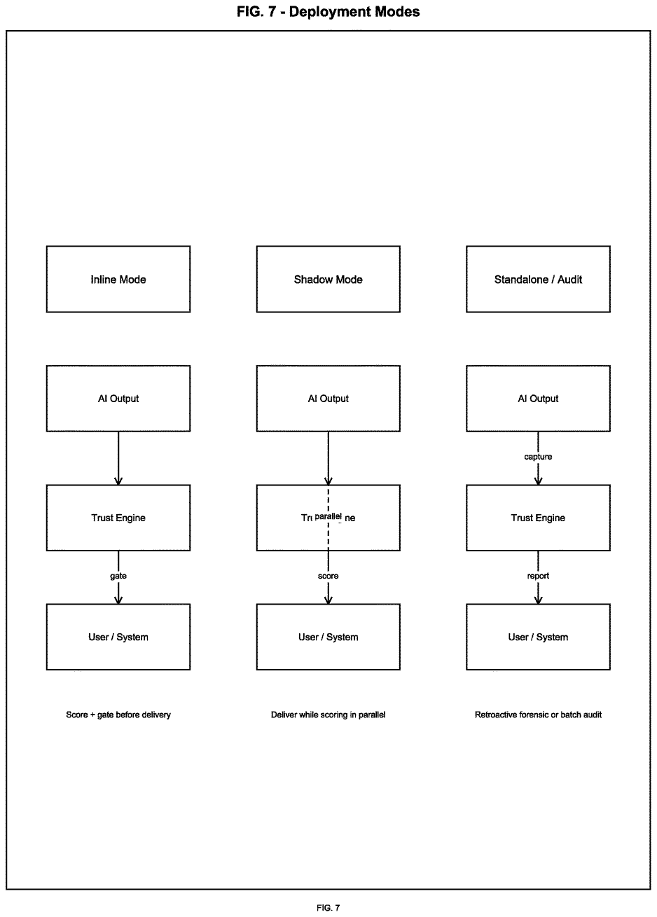

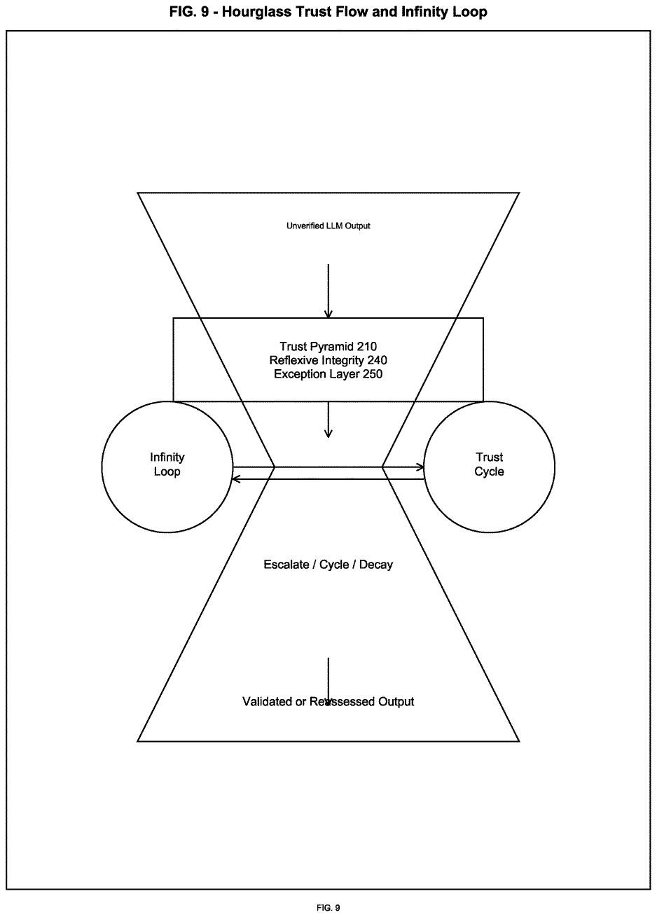

Referring to FIG. 7 and FIG. 9, the invention may include a Snapshot Lock configured to preserve a point-in-time record of earned trust. In one embodiment, the Snapshot Lock records the trust value, ceiling state, module activation state, model version, risk tier, output hash, timestamp, downgrade code, glossary version, continuity state, and human-review status associated with a generation event. The Snapshot Lock may be stored locally, in a distributed store, in a tamper-evident registry, or in a Permanent Audit File that aggregates such records across time.

The Snapshot Lock prevents trust from being treated as portable across revisions. If the content changes, the sources change, the model changes, the module set changes, or the underlying context changes, the system may invalidate the prior lock and require trust to be re-earned. In some embodiments, the Snapshot Lock is accompanied by a visual or machine-verifiable identifier, including a hash string, QR code, blockchain transaction reference, or signed metadata object.

The export-control subsystem may determine whether an output may be released to a user, downstream application, database, report, or regulator-facing channel. The subsystem may append audit metadata to the output, including snapshot identifiers, ceiling flags, reviewer indicators, downgrade labels, or policy warnings. If trust conditions are not satisfied, the system may suppress export, redact the output, hold the output in a dual-signoff queue, or release only a downgraded version with explicit warnings.

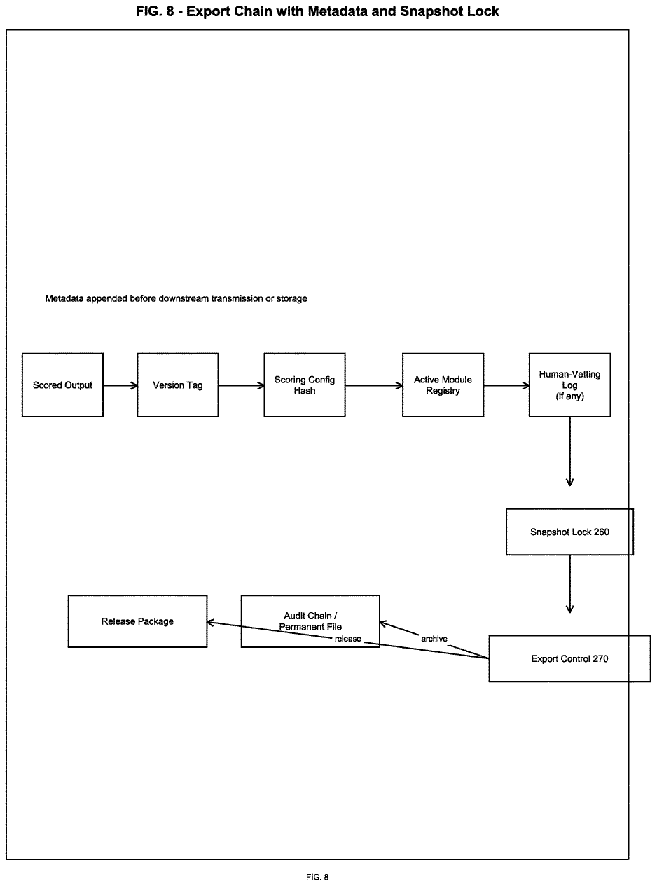

Referring to FIG. 8, the Snapshot Lock 260 binds the trust state to export metadata including version tag, module path, and scoring configuration hash, while the Export-Control Engine 270 blocks release when release conditions are not satisfied.

### 8.10 Agent-Performance Scoring Module (APSM)

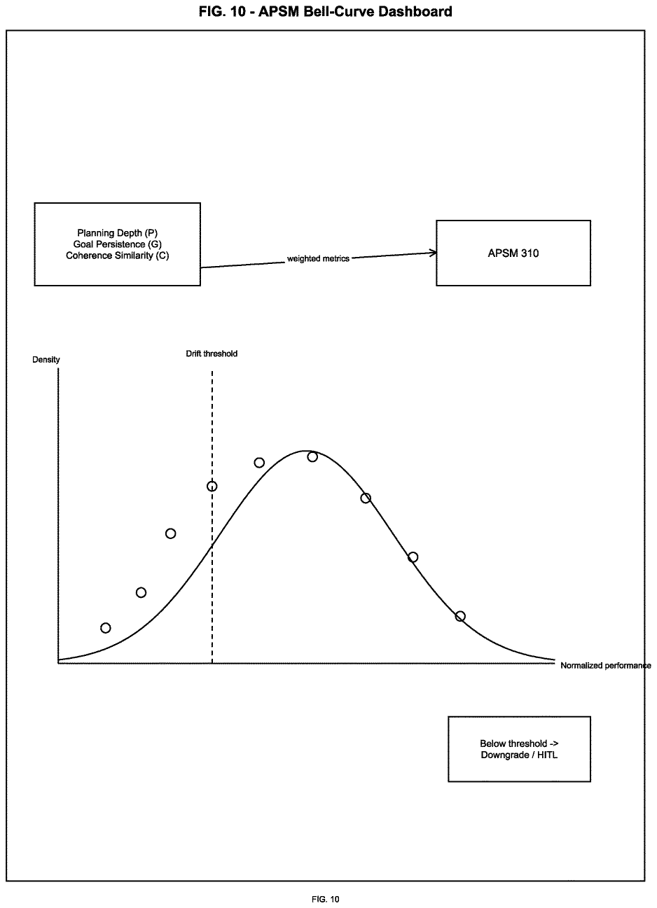

Referring to FIG. 10, the invention may include an Agent-Performance Scoring Module configured to evaluate one or more autonomous or semi-autonomous agents. In one embodiment, the module collects at least three metrics for each agent: planning depth, goal persistence, and coherence similarity. Planning depth may reflect the degree to which an agent produces or follows a structured action sequence. Goal persistence may reflect the extent to which an agent remains aligned with the initiating objective. Coherence similarity may reflect semantic alignment between the agent's output and the governing prompt, context, or workflow state.

In one exemplary embodiment, a raw agent score is computed according to a weighted combination, such as:

R=w1P+w2G+w3c

where P is planning depth, G is goal persistence, C is coherence similarity, and w1, w2, and w3 are configurable weights. A time or workload decay factor may then be applied, such as:

A=R×exp(−lambda×t/T50)

where A is an adjusted agent score, t is elapsed time or processing progression, lambda is a configurable decay constant, and T50 represents a point at which trust or quality is expected to have degraded by approximately half.

The adjusted scores of multiple agents may then be normalized using a bell curve, z-score, percentile ranking, or other comparative distribution. If an agent falls below a drift threshold, the system may downgrade its trust, flag its outputs, reduce orchestration privileges, or escalate the matter for human review. If a configured proportion of agents in a multi-agent workflow fall below threshold, the system may apply an orchestration penalty to the composite result, thereby preventing a cluster of superficially productive but drifting agents from collectively implying reliability they have not earned.

Referring to FIG. 10, the APSM 310 plots each agent on a normalized bell-curve distribution based on planning depth, goal persistence, and coherence similarity, and marks a drift threshold for downgrade or human escalation.

### 8.11 Cross-Model Trust Transfer and Echo Loop

Referring to FIG. 11, the system may preserve trust continuity across model handoffs. Before a handoff from a first model, tool, or agent to a second model, tool, or agent, the system may record a pre-handoff trust packet. After the receiving component completes its work, the system may record a post-handoff trust packet. The system may then compute a trust delta, such as:

Delta=|Tpre−Tpost|

where Tpre is a pre-handoff trust value and Tpost is a post-handoff trust value.

If the delta exceeds a threshold, the system may downgrade the post-handoff output, insert a warning, require segmentation, or suppress output. The pre-handoff and post-handoff packets, together with the delta and any resulting governance action, may be recorded in an Echo Loop registry. This allows auditors or downstream systems to determine not only the final trust value, but how trust changed during handoff.

The handoff logic may be applied to transitions between different large language models, between a model and an external tool, between a model and a human reviewer, between separate agent instances, or between on-device and cloud components.

Referring to FIG. 11, a pre-handoff trust packet 500A and a post-handoff trust packet 500B are compared to compute a trust delta 550, which may be stored in an Echo-Loop Record 560.

### 8.12 T50 Decay Prediction and Segmentation

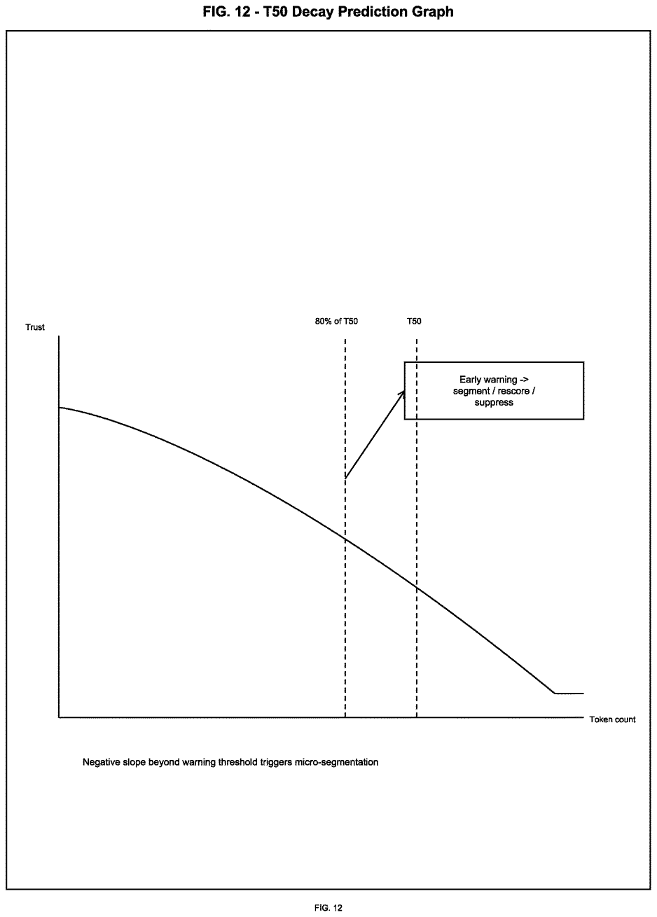

Referring to FIG. 12, the system may predict long-form reliability decay by tracking the slope of trust relative to token count, sequence length, or generation progression. In one embodiment, the system estimates a T50 horizon corresponding to a point at which output trust has degraded by approximately half from an earlier baseline. If the trust slope becomes negative and the current output has progressed beyond a configurable portion of T50, such as eighty percent or another threshold, the system may trigger an early-warning event.

In response to the early-warning event, the system may segment the remaining output into smaller units, re-score each unit independently, insert disclaimers, shorten the response, route the response for review, or block export of the remaining content. This prevents a long answer from inheriting the appearance of coherence even as structural reliability degrades over length or time.

Referring to FIG. 12, the T50 Decay Prediction Module 330 tracks trust against token count, marks the T50 threshold 331, and triggers segmentation when a trust-slope warning threshold is crossed.

### 8.13 Immutable Function Registry, Ledger Anchoring, and Verification

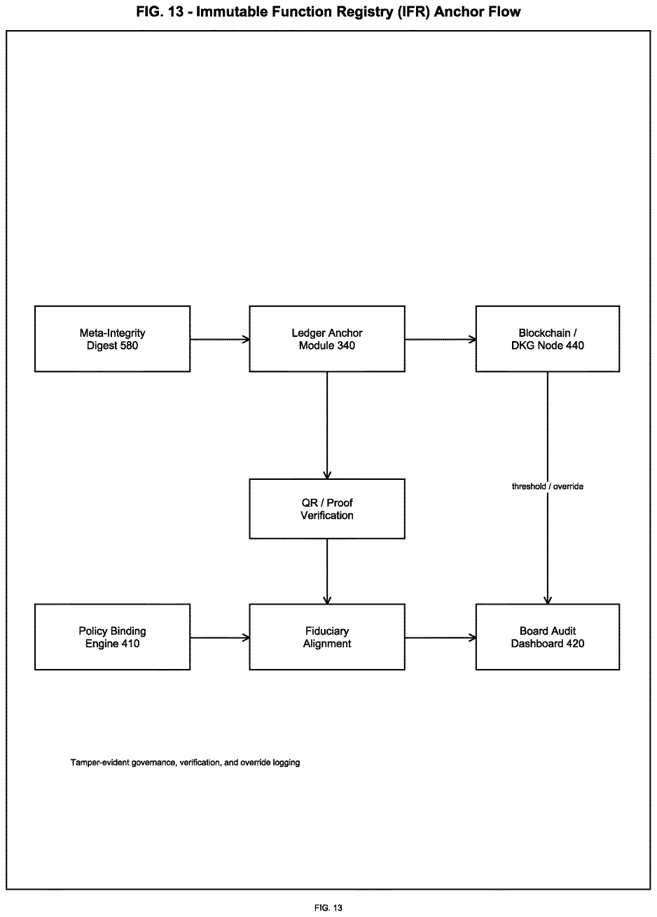

Referring to FIG. 13, the invention may include an Immutable Function Registry or comparable integrity anchoring system. In one embodiment, the system generates a meta-integrity digest from one or more items selected from the following: current trust value, trust slope, ceiling flag, module map, nonce, downgrade code, output hash, reviewer status, and policy profile. The digest may be computed using SHA-256, BLAKE2, Argon2, or another suitable secure function.

The digest may then be stored in a permissioned blockchain, decentralized knowledge graph, distributed ledger, enterprise audit chain, or other tamper-evident system. The corresponding transaction record, anchor identifier, or receipt may be linked to the Snapshot Lock or Permanent Audit File. In some embodiments, the system generates a QR-linked verification interface or a zero-knowledge proof, such as a succinct proof, allowing auditors or downstream systems to verify that a trust event occurred and was preserved without exposing private input text, sensitive output text, or protected personal or enterprise information.

The governance layer may use this anchoring to enforce policy thresholds, fiduciary alignment checks, or board-level overrides. In one embodiment, a fiduciary alignment engine compares output characteristics to mission, policy, or charter requirements and reduces trust when alignment falls below a threshold. In another embodiment, human override votes are recorded, hashed, and linked to the same audit infrastructure, thereby ensuring that overrides are themselves traceable.

Referring to FIG. 13, the IFR Module 340 generates a Meta-Integrity Digest 580, anchors the digest through the Blockchain/DKG Node 440, and exposes a verification artifact through the Verification Portal 430, while the Policy-Binding Engine 410 and Board-Audit Dashboard 420 apply governance logic to release, suppression, or override.

### 8.14 Semantic Integrity Protection and Negation Firewall

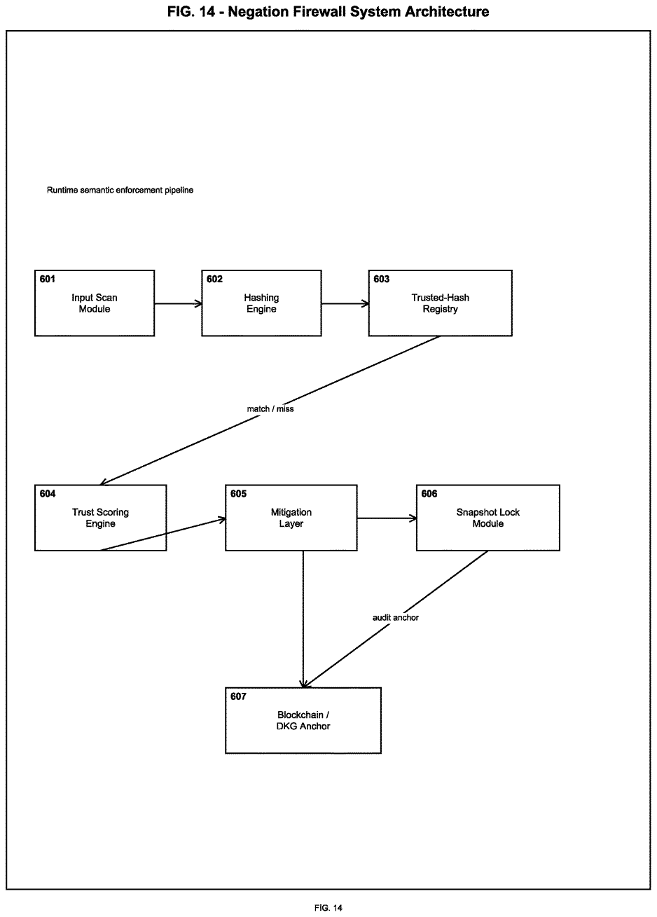

Referring to FIG. 14, the semantic-integrity subsystem may be implemented as a Negation Firewall including an Input Scan Module 601, a Hashing Engine 602, a Trusted-Hash Registry 603, a Trust Scoring Engine 604, a Mitigation Layer 605, a Snapshot Lock Module 606, and an optional Blockchain/DKG Anchor 607. The Input Scan Module 601 identifies semantically sensitive constructs in incoming text; the Hashing Engine 602 canonicalizes and hashes selected phrase spans; the Trusted-Hash Registry 603 stores validated digests and metadata; the Trust Scoring Engine 604 computes trust adjustments based on matches, mismatches, glossary state, and context-lock state; the Mitigation Layer 605 applies downgrade, label, quarantine, or escalation actions; the Snapshot Lock Module 606 captures point-in-time audit data; and the Blockchain/DKG Anchor 607 optionally preserves tamper-evident verification state.

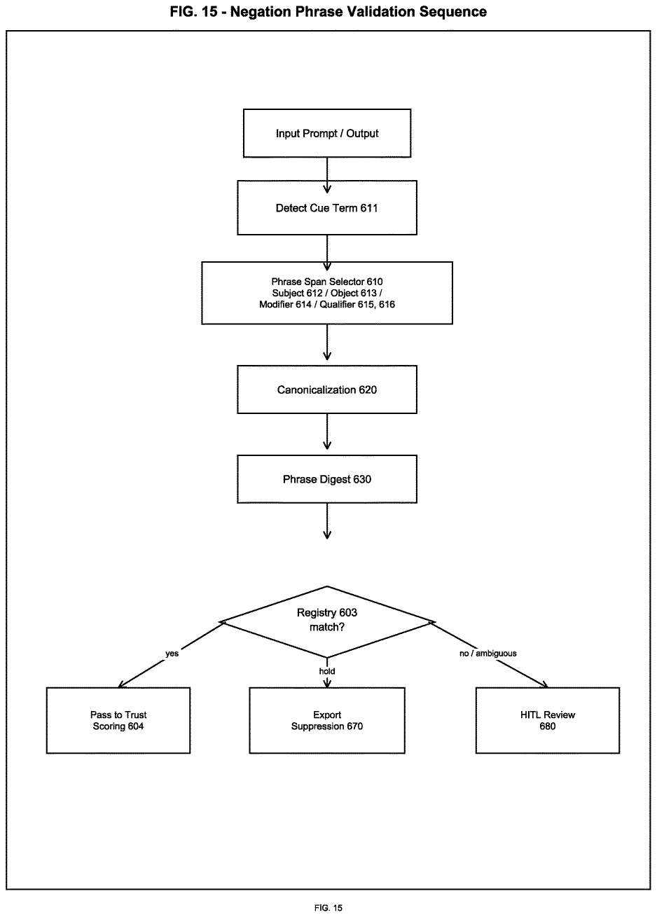

The subsystem may detect a target phrase using lexical triggers, parser output, attention windows, dependency graphs, semantic classification, or policy-defined phrase lists. A contextually relevant span may then be selected and normalized. The normalized span may include a negation cue, the subject of the negation, the affected object, related modifiers, temporal qualifiers, jurisdictional qualifiers, or similar contextual terms. The system then generates a cryptographic hash of the normalized span and compares the hash to a Trusted-Hash Registry containing approved canonical constructs and associated semantic metadata. As shown in FIG. 15, a phrase span may be selected by a Phrase Span Selector 610 to include a Cue Term 611, and one or more of a Subject Term 612, Object Term 613, Modifier 614, Temporal Qualifier 615, or Jurisdictional Qualifier 616. A Canonicalization Engine 620 transforms the phrase span into a standardized form, from which a Phrase Digest 630 is generated and compared against the Trusted-Hash Registry 603. Validation failure may route the output to an Export Suppression Queue 670 or a HITL Review Queue 680.

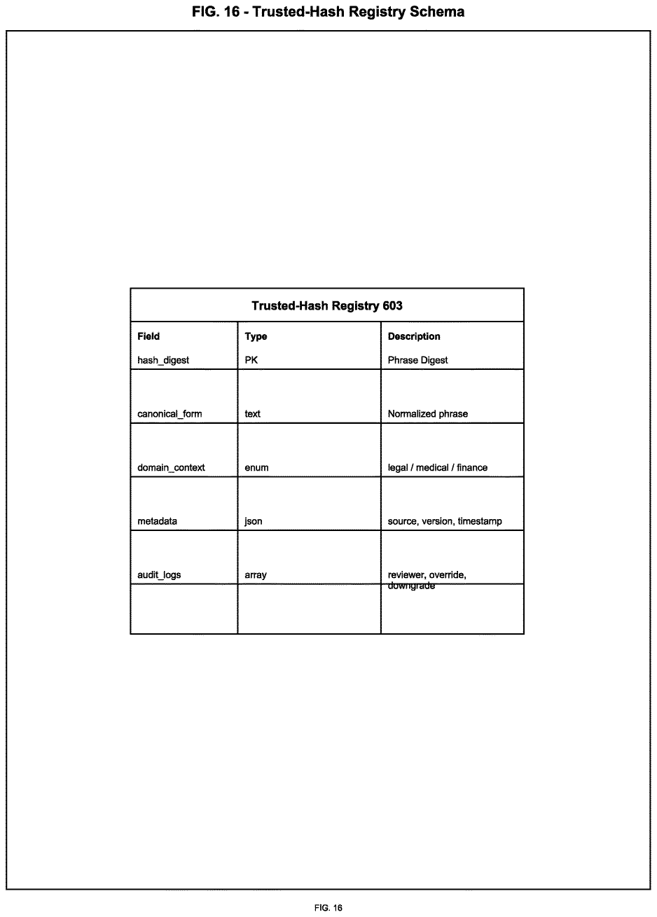

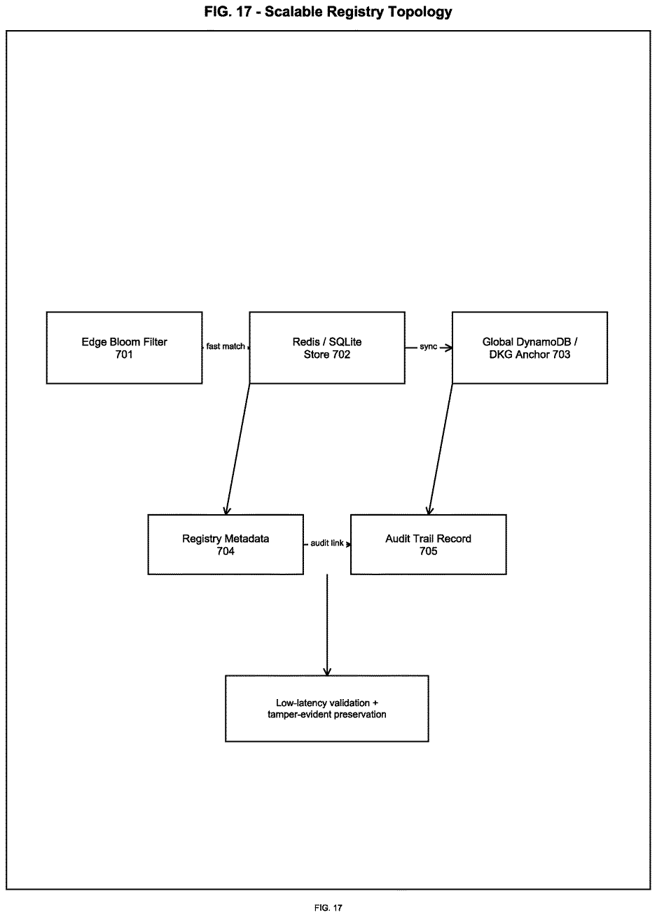

If the hash matches an approved record, the system may permit continuation. If the hash mismatches, is absent, or is ambiguous, the system may downgrade trust, annotate the output, quarantine the output, suppress export, or escalate for human review. In some embodiments, the event is also snapshot-locked and anchored for audit. Referring to FIG. 16, the Trusted-Hash Registry 603 may store a digest field, a canonical phrase field, a domain-context field, a metadata field, and an audit-log field. Referring to FIG. 17, the registry may be deployed using an Edge Bloom Filter 701, an In-Memory Redis/SQLite Store 702, and a Global DynamoDB/DKG Anchor 703.

The semantic-integrity subsystem may further include a Glossary Lock and a Context Locking Q&A engine. The Glossary Lock ensures that defined terms, particularly regulated or domain-sensitive terms, are used consistently unless an authorized override occurs. The Context Locking Q&A engine may collect a small number of anchoring questions at session initiation, hash or otherwise preserve the responses, and compare future outputs to those anchors to detect contextual drift. Runtime semantic drift checks may occur periodically or upon trigger events. An export suppression module may prevent dissemination of content that fails semantic-integrity validation or that contradicts glossary or context locks.

The Negation Firewall may operate as a standalone subsystem or as one module within the broader AI-DigiScore architecture.

### 8.15 Auxiliary Governance Modules

The invention may further include auxiliary governance modules. A Trust-Efficiency Toggle may permit a user or policy engine to place the system in a high-trust mode, in which the full module set executes, or an efficiency mode, in which certain checks are bypassed. When efficiency mode is active, the system may enforce a lower trust ceiling and record that the result was generated under reduced governance coverage.

A Light Prompts module may inject skeptic-oriented follow-up prompts, requests for evidence, or counter-argument requirements, particularly where a user's expertise level is low or where the risk tier is elevated. A Quantum-Enhanced Variance Validator or other ensemble-variance module may sample multiple runs or multiple model paths and penalize unstable output patterns. A Memory-Compression and Confidence-Drift monitor may detect repetitive low-information responses, rising confidence without added support, or similar inflationary patterns. An XPAT heuristic module may detect indicators of sparse data, under-documented regions, or emerging-market uncertainty and may reduce trust or attach an XPAT_GAP flag when such conditions exist.

These auxiliary modules may be optional, but they extend the ability of the system to tailor enforcement to environment, user sophistication, and risk.

### 8.16 Deployment Modes and Exemplary Uses

Referring to FIG. 8, the system may operate in inline mode, shadow mode, or standalone mode. In inline mode, content is scored and governed before delivery. In shadow mode, content may be delivered while scoring and audit records are generated in parallel for review or monitoring. In standalone mode, the system may be applied to existing content for forensic analysis, compliance review, retrospective scoring, or regulatory replay.

The system may be applied in healthcare to prevent diagnostic contradictions, preserve exam limitations, and protect negations. It may be applied in legal workflows to prevent semantic reversal of liability, guilt, or enforceability language. It may be applied in finance to prevent disclosure drift, unsupported confidence, or stale-memory carryover in reporting. It may be applied in education to score AI-assisted explanations for earned trust and critical-thinking value. It may be applied in agentic environments to prevent agent sprawl, pseudo-productivity, and orchestration-level drift. It may also be applied in sovereign or enterprise settings where auditability, policy enforcement, and controlled export are required.

### 8.17 Implementation Notes and Equivalents

Any of the modules described herein may be combined, subdivided, reordered, distributed, or omitted according to implementation needs without departing from the invention. Module execution may be synchronous or asynchronous. Storage may be local, remote, cached, replicated, or ledger-backed. Trust scores may be numeric, categorical, vector-based, or policy-band-based. Human review may be performed by a single reviewer, multiple reviewers, a board, a regulator-facing workflow, or a designated enterprise controller.

Similarly, the invention is not limited to any particular model vendor, prompt structure, programming language, database, ledger, or interface. The term “blockchain” includes permissioned ledgers and comparable tamper-evident infrastructures. The term “human-in-the-loop” includes any authorized human review, approval, co-signature, or override. The term “earned trust” includes any bounded trust state derived from the execution of one or more governance or validation modules. The term “AI-generated content” includes text, code, images, audio-derived transcripts, summaries, reports, structured records, action plans, or agent outputs.

Accordingly, the present invention provides a unified runtime architecture that transforms AI governance from passive description into active enforcement. Trust is computed, bounded, challenged, preserved, and, where necessary, revoked before downstream reliance occurs.

### 8.18 Exemplary Embodiments

The following embodiments are provided to illustrate implementation of the invention in specific environments and should not be construed as limiting.

### 8.18.1 Medical Semantic-Integrity Embodiment

In one embodiment, the system is deployed in a clinical or radiology workflow in which an AI model generates a summary, discharge note, impression summary, or clinician-facing explanation based on medical imaging findings, reports, or structured clinical data. The output is first processed by the pre-logic validator to confirm that required glossary terms, limitation language, and restricted-diagnosis controls are active. The continuity engine verifies that any prior session history, prior imaging references, and contextual assumptions are current and properly linked to the active encounter. The semantic-integrity subsystem then scans the output for semantically sensitive constructs, including negations, denials, exclusions, uncertainty qualifiers, and exam limitations.

If the subsystem detects a phrase span containing a construct such as a negative finding, it canonicalizes the phrase span, generates a cryptographic digest, and compares the digest with a trusted-hash registry. If the digest matches, the output may proceed to trust scoring. If the digest does not match, or if the phrase span is ambiguous, the system may downgrade the trust value, add an annotation, quarantine the output, or block downstream release. In this embodiment, the system prevents release of an AI-generated output that changes, omits, or ambiguously restates a clinically material negation or limitation statement unless the output is revalidated or reviewed by an authorized human.

The resulting output, if approved for release, is stored with a snapshot lock including the trust value, validation status, model identifier, timestamp, and output digest. If the report is later revised, the snapshot lock is invalidated and trust must be re-earned.

### 8.18.2 Legal and Compliance Disclosure-Drift Embodiment

In another embodiment, the system is deployed in a legal, regulatory, or compliance workflow in which an AI model generates a summary, filing support memorandum, disclosure analysis, or risk statement. The pre-logic validator confirms that defined terms, required disclaimers, materiality thresholds, and jurisdiction-specific language are present. The continuity engine evaluates whether prior drafts, source documents, or cited authorities are stale, mismatched, or incompletely carried forward.

The reflexive integrity layer evaluates whether the output is overstating certainty, collapsing distinctions, or presenting a conclusive narrative unsupported by underlying source structure. If narrative dominance, unsupported confidence, or structural omission is detected, the exception layer routes the output to downgrade, quarantine, or manual review. In one implementation, the export-control engine prevents submission, filing, publication, or circulation of the output until trust thresholds are satisfied and a point-in-time audit record is created.

This embodiment is particularly useful where disclosure drift, omission of qualifying language, stale legal assumptions, or overconfident compression of nuanced source material would create legal or compliance risk.

### 8.18.3 Agentic Orchestration and Cross-Model Handoff Embodiment

In another embodiment, the system governs a workflow comprising a plurality of AI agents or a plurality of handoffs between different models, tools, or orchestration stages. Each agent is scored using planning depth, goal persistence, and coherence similarity. A raw performance score is generated and then adjusted using a decay factor associated with a task-specific T50 horizon. The adjusted score is normalized across the active orchestration set.

When an agent falls below a drift threshold, the system downgrades the agent, limits its orchestration privileges, or routes its output for human review. If multiple agents fall below threshold, the system may reduce a composite orchestration trust value. When output is handed from a source model to a target model, the system creates a pre-handoff trust packet and a post-handoff trust packet, computes a trust delta, and records the result in an Echo-Loop record. If the delta exceeds a threshold, or if the trust slope becomes negative beyond a configured portion of T50, the system may segment remaining content into smaller units, rescore each unit, and suppress or annotate units that fail release criteria.

This embodiment is useful for long-form generation, agentic task execution, and multi-model workflows in which trust may decay or become unstable across successive processing stages.

### 8.18.4 Tamper-Evident Audit and Governance Embodiment

In another embodiment, the system generates a meta-integrity digest from trust-state data associated with an output, including one or more of trust value, trust slope, ceiling flag, module activation map, downgrade code, or nonce. The digest is stored in a tamper-evident ledger, such as a permissioned blockchain, decentralized knowledge graph, or append-only audit chain. A verification record may be generated in the form of a transaction identifier, QR-readable artifact, or proof object.

A policy-binding engine determines whether the output may be released, held, escalated, or overridden. Where an override is permitted, the system may require approval by one or more authorized reviewers and may hash and store the override action in the same audit infrastructure. In some embodiments, a fiduciary alignment engine compares the output to a policy representation, mission statement, or governance charter and reduces trust when alignment falls below threshold.

This embodiment provides regulator-facing replay, board-level review traceability, override accountability, and immutable preservation of trust-state transitions.

### 8.19 Exemplary Structural Reasoning-Integrity Evaluation

In some embodiments, the reflexive integrity layer generates a structural reasoning-integrity metric derived from one or more of a Perspective Deviation Score, a Narrative Dominance Index, a Self-Referencing Bias Detector, a coherence similarity metric, a trust-delta consistency metric, an unresolved-exception count, or a contradiction measure. The structural reasoning-integrity metric does not replace the trust value, but instead functions as an integrity adjustment, gating condition, or downgrade trigger for trust elevation.

In one implementation, the system reduces or caps a trust value when the structural reasoning-integrity metric indicates that the output is rhetorically strong but structurally unsupported. In another implementation, the system requires explicit human acknowledgment before elevating an output whose structural reasoning-integrity metric falls below threshold. In this way, the system distinguishes between fluent expression and earned reasoning integrity.

### 8.20 Exemplary Scoring And Decision Logic

The scoring and decision logic may be implemented in many forms. In one exemplary embodiment, an output trust value T is determined according to:

T=min(C, max(0, B−P+H))

where B is a base structural trust value, P is an aggregate penalty term, H is a human-review or verified-support adjustment, and C is an applicable trust ceiling.

In one implementation, the aggregate penalty term P may include one or more components associated with semantic mismatch, continuity drift, unresolved exception state, reflexive integrity failure, model-handoff degradation, memory compression, uncertainty indicators, or policy misalignment.

In another exemplary embodiment, a structural reasoning-integrity metric R is derived from weighted integrity components according to:

R=a1D+a2N+a3S+a4C+a5E

where D represents a deviation component, N represents a narrative-dominance component, S represents a self-referencing component, C represents a coherence or consistency component, E represents an exception-based component, and a1 through a5 are configurable weights.

The foregoing equations are illustrative only. Other additive, subtractive, multiplicative, probabilistic, rule-based, vector-based, categorical, or learned scoring formulations may be used without departing from the invention.

### 8.21 Additional Implementation Details

In certain embodiments, different release policies may be applied for different risk tiers. A low-risk profile may permit lower structural thresholds and reduced retention. A medium-risk profile may require snapshot locking and reflexive integrity checks. A high-risk profile may require a full trust-enforcement stack, lower release thresholds, semantic-integrity enforcement, and human review for any elevation above a trust ceiling.

In certain embodiments, the system supports rollback validation. If an output is modified after release, or if underlying source material changes, the prior point-in-time audit record may be invalidated and a new validation cycle initiated. In certain embodiments, the system performs mid-generation or mid-session revalidation to detect context drift, source decay, or semantic instability before a final output is completed.

In certain embodiments, the system preserves unresolved exceptions in a dormant state and resurfaces them when reused content, repeated claims, or related workflows reappear. In certain embodiments, the system tracks module execution paths to determine whether a later output improperly inherits trust from an earlier output that traversed a different governance path.

### 8.22 Computer Implementation

The invention may be implemented on a general-purpose computing system, a distributed computing system, an on-premise enterprise system, a sovereign or regulated infrastructure, an edge device, or a cloud-native service architecture. Instructions for performing the methods described herein may be stored on one or more non-transitory computer-readable media and executed by one or more processors.

The modules described herein may be implemented as software services, libraries, middleware components, containerized services, policy engines, workflow orchestrators, or combinations thereof. Data associated with trust-state records, snapshots, trusted-hash registries, Echo-Loop records, and verification artifacts may be stored in relational databases, key-value stores, append-only logs, object stores, graph stores, or tamper-evident ledgers.

### Description of Related Art and Distinction From Certain References

Various known systems address isolated aspects of artificial intelligence reliability, including explainability, audit logging, confidence tagging, content classification, moderation, prompt security, contradiction detection, and post-hoc review. However, such systems are generally limited to one or more narrow functions and do not provide a unified runtime architecture for determining whether AI-generated content has earned trust, whether such trust must remain capped, whether trust must be revoked upon drift or inconsistency, or whether the content may be exported or relied upon downstream.

Certain known systems focus primarily on explainability or transparency. For example, IBM Trust AI, identified in the applicant's earlier materials as U.S. Publication No. US 20220269025 A1, emphasizes explainability layers, trust tags, attention visualization, and trace paths. Such systems may aid post-hoc interpretation of model behavior, but they do not teach or suggest a runtime trust-enforcement architecture having a trust ceiling on AI-only outputs, a reflexive integrity layer that audits the scoring process itself, a point-in-time snapshot lock that invalidates upon later model or context change, or export-control logic that blocks downstream release when structural conditions fail.

Certain known systems focus on static logging or audit trails. For example, the applicant's prior-art matrix identifies U.S. Publication No. US 20220405559 as a “Content Audit Trail System” directed to static audit logging. Such systems do not teach a modular trust-governance framework in which scoring, downgrade, exception routing, continuity enforcement, human-review thresholds, and snapshot invalidation operate together in real time to control whether an output is trusted or releasable. Similarly, references characterized in the prior filings as “Adaptive Content Filtering” and “Trust Scoring for AI Responses,” including U.S. Publication Nos. US 20210044801 and US 20220322379, may filter or assign scores to content but do not teach multi-module gating, version-locked trust preservation, reflexive audit checkpoints, or enforced trust ceilings tied to release conditions.

Other known systems focus on content origin or text classification rather than earned trust. The applicant's prior-art matrix identifies U.S. Publication No. US 20230108761 as an AI text-classification system directed to distinguishing AI-generated text from human-generated text. Such classification is materially different from determining whether an output is structurally qualified for trust. Likewise, structured generative scoring systems, including the reference identified in the applicant's materials as U.S. Publication No. US 20230246891, may assign preset confidence levels or scoring categories, but do not teach or suggest a combined architecture in which trust is bounded by a ceiling, conditioned on glossary alignment and module flow, downgraded upon drift, preserved through snapshot locking, and blocked from export when structural traceability is incomplete.

Certain references address input-layer security or logic enhancement rather than output-governance enforcement. In the Negation Firewall materials, the applicant identified Microsoft's U.S. Publication No. US 20250173438 A1 as addressing prompt-injection detection and adversarial misuse at the input layer. That reference is materially different from the present invention because it does not address output-integrity enforcement, does not perform cryptographic phrase validation, and does not teach trust ceilings, glossary enforcement, semantic mitigation routing, or trust snapshots. Likewise, the DeepMind reference identified as U.S. Publication No. US 20250156654 A1 proposes a dialectical logic framework to improve logical reasoning or debate capabilities in language models, but it does not teach phrase-level structural enforcement, trusted-hash validation, downgrade controls, or release gating. Similarly, the Amazon reference identified as U.S. Publication No. US 20240394412 A1 addresses privacy inconsistency detection across documents, but does not teach runtime semantic-negation enforcement, cryptographic phrase verification, trust scoring, or export suppression tied to semantic integrity.

The applicant's earlier Negation Firewall filing further explains that the cited explainability and inconsistency-detection systems do not teach a complete runtime semantic-enforcement architecture. More particularly, they do not teach detecting a semantically sensitive phrase span, canonicalizing the phrase span, generating a cryptographic digest, comparing that digest against a trusted registry of approved canonical phrase spans, and then conditionally downgrading, labeling, quarantining, suppressing, or escalating the output based on the comparison result, together with snapshot locking and downstream export control.

The applicant's AI-DigiScore materials likewise distinguish the present architecture from comparator systems by module-level combination. As set forth in the applicant's differentiation matrix, the present architecture uniquely combines a Trust Pyramid with an AI-only ceiling, reflexive integrity tools including perspective deviation and self-referencing bias detection, Black Hole detection, Snapshot Lock, downgrade-on-drift logic, infinity-loop detection, pre-logic claim alignment, multiple deployment modes, skeptic-default posture, and blockchain or export integration. The applicant's materials further state that no known system combines Trust Pyramid enforcement with an audit-bound trust ceiling, reflexive and downgrade logic enforced in real time, Snapshot Lock with exportable score and structure state, human-in-the-loop escalation tied to blockchain exportability, and hourglass escalation logic with infinite-loop protection.

Accordingly, to the extent any of the foregoing references are considered relevant art, they do not teach or suggest the claimed combination of features set forth herein. In particular, they do not teach or suggest:
(i) a bounded trust framework in which AI-only outputs are capped absent human approval;
(ii) a pre-logic gate requiring structural prerequisites before trust elevation;
(iii) a continuity engine that detects stale memory reuse, session drift, source decay, or hallucinated carry-over;
(iv) a reflexive integrity layer that audits the scoring process itself for unsupported confidence, self-reinforcing logic, or narrative overreach;
(v) an exception layer that actively downgrades, quarantines, or escalates uncertain outputs;
(vi) a snapshot-lock mechanism that preserves trust as a point-in-time, invalidatable state rather than a permanent property;
(vii) cross-model trust-transfer and T50 decay controls that maintain trust continuity through handoffs and long-form generation;
(viii) semantic-integrity enforcement through phrase-span canonicalization, cryptographic digest generation, trusted-registry comparison, and mitigation routing; and
(ix) optional anchoring of trust-state or semantic-validation data to a tamper-evident ledger for downstream verification, policy enforcement, or regulator-facing replay.

For at least these reasons, the present invention is not merely a confidence-scoring model, a moderation filter, a provenance logger, a text classifier, an explainability overlay, or a negation detector in isolation. Rather, it is a runtime trust-enforcement architecture that determines whether AI-generated content may earn trust, retain trust, lose trust, or be blocked from downstream reliance based on structural validation, semantic integrity, continuity controls, audit preservation, and release-governance rules.

### GLOSSARY OF DEFINED TERMS

The following glossary is provided for clarity and consistency of usage throughout this specification and the claims. Unless expressly stated otherwise, these definitions are illustrative and are not intended to limit the claimed invention to the examples recited.

### AI-DigiScore™

A modular trust-enforcement and governance architecture configured to evaluate, restrict, preserve, and document earned trust in AI-generated content using scoring, continuity validation, exception routing, snapshot preservation, and human-review controls.

### Agent-Performance Scoring Module (APSM)

A module configured to appraise a plurality of AI agents using at least planning depth, goal persistence, and coherence similarity, and to normalize resulting scores across an orchestration environment for downgrade, escalation, or review.

### Audit Hash

A cryptographic value associated with a point-in-time audit record, snapshot, phrase digest, or meta-integrity digest and used to verify integrity, traceability, and tamper evidence.

### Black Hole Condition

A structural failure state in which an output appears complete, fluent, or final while lacking sufficient traceability, structural support, scoring support, glossary linkage, or claim support to justify its asserted confidence.

### Canonicalization

A normalization process by which semantically related variants of a phrase, expression, or construct are transformed into a standard form prior to hashing, comparison, storage, or validation.

### Ceiling State

A state variable indicating whether a trust ceiling has been applied to a trust value associated with an output.

### Coherence Similarity

A metric representing semantic alignment between an AI-generated output and a governing prompt, context, workflow objective, or other reference state.

### Confidence State

An expressed, inferred, displayed, or computed level of confidence associated with an output, whether derived from content, scoring, policy, or metadata.

### Context Locking Q&A

A mechanism that captures one or more anchoring questions and corresponding responses at session initiation and uses those responses, or hashes derived therefrom, as a reference checkpoint for later semantic or contextual validation.

### Continuity Engine™

A module configured to detect stale memory reuse, prompt drift, session drift, source decay, glossary staleness, hallucinated carry-over, or other continuity failures across time, sessions, or model changes.

### Day 32 Revalidation Logic

A delayed revalidation mechanism in which uncertain, drift-prone, or quarantined outputs are automatically rechecked after a defined interval or event trigger before trust elevation or reuse is permitted.

### Deployment Mode

One of multiple operating configurations of the trust-enforcement system, including inline, shadow, and standalone or audit mode.

### Downgrade Code

A structured code, tag, or identifier applied when a trust value is reduced or a validation failure is detected, thereby enabling traceable mitigation, routing, auditing, or downstream handling.

### Earned Trust

Trust that is established through structural validation, scoring, continuity checks, semantic validation, exception handling, and, where required, human or audit confirmation, and not merely through fluency, confidence, or stylistic coherence.

### Echo-Loop™

A logging and continuity mechanism that records paired pre-event and post-event trust states, including handoff records and trust deltas, to preserve a traceable history of changes in trust across models, agents, or workflow stages.

### Exception Layer™

A governance subsystem configured to identify, reroute, quarantine, downgrade, suppress, or escalate outputs that are ambiguous, incomplete, uncertain, structurally unsupported, semantically unstable, or otherwise unsuitable for immediate downstream reliance.

### Expat Mindset

An operational governance philosophy implemented within the system to prioritize exceptions over averages, treat missing or contradictory context as a material risk signal, resist premature consensus, and require additional validation before trust is elevated.

### Export Control

A set of release, suppression, blocking, labeling, or routing rules governing whether an output may be transmitted, saved, displayed, reused, or integrated into downstream systems.

### Export Suppression

A control action that prevents an output from being released, stored, reused, or propagated when structural, semantic, or policy requirements are not satisfied.

### Fiduciary Alignment Engine

A module configured to compare an output to a mission statement, policy representation, governance charter, or similar reference and to limit or reduce trust when alignment falls below a threshold.

### Glossary Alignment

Conformity of an output to defined terms, expected meanings, or controlled vocabulary required by a glossary, policy, or domain rule.

### Glossary Lock

A control mechanism by which defined meanings for domain-specific terms are established and enforced during generation, validation, or review, such that contradiction or misuse triggers downgrade, suppression, or escalation.

### Goal Persistence

A metric representing the extent to which an AI agent or model remains aligned with an initiating objective rather than drifting into unrelated, inconsistent, or self-generated goals.

### High-Trust Mode

An operating mode in which a fuller set of governance, validation, or audit routines is executed before trust elevation or downstream release is permitted.

### Human-in-the-loop (HITL)

A review, approval, correction, override, or validation process performed by an authorized human reviewer as part of trust elevation, exception handling, or release control.

### Immutable Function Registry (IFR)

A module or registry configured to generate, preserve, and optionally anchor a meta-integrity digest or related trust-state data in a tamper-evident system for downstream verification, policy enforcement, or audit replay.

### Infinity Loop Detector

A watchdog function configured to identify repeated or recycled scoring logic, structurally cloned trust signals, or recursive reuse patterns that create the appearance of consistent validation without substantive progression.

### Light Prompts™

Skeptic-oriented prompts, counter-questions, or evidence-seeking prompts injected into a workflow to elicit supporting information, expose weaknesses, or improve trust validation without permitting trust to exceed an applicable ceiling.

### Meta-Integrity Digest

A cryptographic digest derived from trust-state data, including one or more of trust slope, ceiling flag, module activation map, nonce, downgrade code, or related governance metadata, and used for audit anchoring or verification.

### Minimum Viable Compliance State (MVCS)

A partial deployment state in which selected governance modules are active to provide limited but meaningful trust enforcement, even when a full audit or anchoring stack is not enabled.

### Model Identifier

A versioned identifier representing the model, agent, workflow component, or inference engine that produced or transformed a given output.

### Module-Activation Map

A data structure, including a bitmask or similar representation, indicating which validation, scoring, governance, or audit modules executed for a given output.

### Narrative Dominance Index (NDI)

A metric configured to identify when an output exhibits excessive narrative closure, storytelling dominance, or framing intensity relative to structured support.

### Negation Firewall

A modular runtime semantic-enforcement layer configured to detect, hash, validate, and apply mitigation actions to outputs containing negation phrases or other semantically sensitive constructs in order to preserve semantic integrity.

### Non-Linear Trust Progression Model

A trust progression framework in which outputs may advance rapidly upon satisfying structural gates or experience immediate downgrade upon validation failure, such that trust is not treated as cumulative absent checkpoint satisfaction.

### Perspective Deviation Score (PDS)

A metric configured to measure divergence between an output and a prompt, objective, evidence base, or expected structural framing.

### Phrase Digest

A cryptographic output generated from a canonicalized phrase span for comparison against a trusted registry or for storage in an audit or validation system.

### Phrase Span

A selected unit of text containing a cue term and one or more contextual terms used for semantic validation, hashing, registry comparison, or mitigation decisions.

### Planning Depth

A metric representing the degree to which an AI agent or model output reflects structured sequencing, task decomposition, branching, or non-trivial action planning.

### Point-in-Time Audit Record

A preserved record associated with an output at a defined moment, including trust-state data and related metadata sufficient to verify how that output was scored, governed, and released at that time.

### Pre-Logic Validator

A validation gate configured to determine whether threshold structural prerequisites, including glossary alignment, module presence, claims alignment, or related conditions, are satisfied before trust elevation or release.

### Reflexive Integrity Layer™

A self-audit layer configured to test whether the scoring or governance process itself is overstating confidence, reusing unsupported assumptions, or otherwise generating structurally unjustified results.

### Release Policy

A rule set, profile, or control condition governing whether a scored output may be released, downgraded, labeled, held, segmented, quarantined, or blocked.

### Risk-Tier Escalator

A policy mechanism that lowers governance thresholds, tightens controls, or changes enforcement mode when outputs are classified within a higher-risk category.

### Score Cap

A maximum trust value assignable to an output in the absence of one or more required review conditions, including in some embodiments human approval.

### Semantic Drift

A structural error condition in which meaning changes, broadens, narrows, or inverts over time, across turns, across models, or across revisions, including shifts from denial to affirmation.

### Semantic Trust Packet

A machine-readable trust-state bundle associated with an output, comprising at least a trust value, a ceiling flag, a module-activation map, and a cryptographic digest, and optionally other metadata.

### Self-Referencing Bias Detector (SRBD)

A metric or detector configured to identify when an output, score, or reasoning path is being justified by prior unvalidated outputs or recursive internal references rather than external or structural support.

### Skeptic Mode 905

A governance profile in which outputs are presumed structurally untrusted unless validated through enforced module checks, logic gates, and review conditions.

### Snapshot Lock™

A mechanism configured to capture and preserve a point-in-time trust state, including score, model version, module path, glossary status, timestamp, and related metadata, so that reuse or export requires traceability and, where appropriate, revalidation.

### T50

A decay reference point representing an output length, generation stage, or progression point at which trust, quality, or reliability is expected to have decreased by approximately one-half relative to an earlier baseline.

### Tamper-Evident Ledger

A blockchain, distributed ledger, decentralized knowledge graph, append-only log, or other system configured to preserve integrity evidence for stored digests, trust events, or audit records.

### Trust Ceiling

A configurable upper bound on a trust value that cannot be exceeded unless specified review, validation, or policy conditions have been satisfied.

### Trust Delta

A measured difference between two trust states, including a pre-handoff trust state and a post-handoff trust state.

### Trust-Efficiency Toggle™

A control that switches between a higher-rigor validation mode and a reduced-check efficiency mode, wherein the reduced-check mode may impose a lower trust cap or additional labeling requirements.

### Trust Pyramid™

A multi-level trust architecture configured to classify outputs according to earned trust and to limit the display, elevation, or downstream use of outputs based on validation state and applicable ceilings.

### Trust Quarantine

A temporary or indefinite downgrade state applied to outputs that fail structural scoring, semantic validation, or release conditions but are not necessarily demonstrably false, wherein reuse, export, or trust elevation is blocked pending revalidation or review.

### Trust Slope

A measure of the direction or rate of change of trust over token count, generation time, workflow progression, or successive scoring events.

### Trusted-Hash Registry

A registry storing canonicalized phrase spans, phrase digests, and associated semantic metadata for use in semantic-integrity validation.

### Uncertainty Indicator

A flag, code, or packet field indicating that an output depends on sparse records, under-documented environments, unresolved ambiguity, or comparable uncertainty conditions.

### Version Indicator

A value identifying the operative system, model, glossary, ruleset, or module configuration associated with an output or audit record.

### XPAT_GAP

An uncertainty or downgrade flag appended when a data-gap indicator, sparse-documentation condition, or emerging-market uncertainty heuristic is detected.

1. A computer-implemented system for runtime governance of AI-generated content, the system comprising: one or more processors and memory; an input interface configured to receive an output generated by at least one artificial intelligence model; a pre-logic validator configured to determine whether required glossary, context, and module prerequisites are satisfied for the output; a continuity engine configured to evaluate freshness, session lineage, and structural consistency associated with the output; a reflexive integrity engine configured to evaluate whether a confidence state associated with the output is structurally supported; an exception routing engine configured to downgrade, quarantine, or escalate the output when at least one validation failure is detected; a snapshot-lock store configured to preserve, for the output, a point-in-time audit record comprising a trust value, a ceiling state, a model identifier, and a cryptographic digest; and an export-control engine configured to permit downstream release of the output only when the point-in-time audit record satisfies a release policy.

2. The system of claim 1, wherein the ceiling state limits an AI-only trust score to not greater than 7.0 on a ten-point scale unless a human approval event is recorded.

3. The system of claim 1, wherein the continuity engine evaluates at least one of glossary freshness, session-specific memory boundaries, source decay, citation age, and structural drift.

4. The system of claim 1, wherein the reflexive integrity engine computes at least one structural reasoning-integrity metric comprising a Perspective Deviation Score, a Narrative Dominance Index, or a Self-Referencing Bias Detector.

5. The system of claim 1, wherein the exception routing engine places the output into a trust quarantine state or a revalidation path when the output is structurally incomplete or semantically unstable.

6. The system of claim 1, wherein the snapshot-lock store preserves, in the point-in-time audit record, the trust value, a timestamp, a module path, a version indicator, and an audit hash, and wherein the export-control engine blocks external release unless the point-in-time audit record satisfies snapshot, human-review, and structural trace thresholds.

7. The system of claim 1, wherein the point-in-time audit record further comprises a module-activation map, a downgrade code, a glossary version indicator, and a release-policy identifier.

8. The system of claim 1, wherein invalidating the point-in-time audit record comprises invalidation upon detecting at least one of a glossary change, a source-set change, a module-path change, a model-version change, or a context-anchor change affecting the output.

9. A computer-implemented method for preserving trust continuity across model handoffs, the method comprising: generating a pre-handoff trust packet for output transmitted from a source model; generating a post-handoff trust packet for output received from a target model; computing a trust delta between the pre-handoff trust packet and the post-handoff trust packet; when the trust delta exceeds a threshold, downgrading, labeling, suppressing, or escalating downstream release of the output; monitoring a trust slope relative to token count or generation progression; and when the trust slope becomes negative beyond a configured portion of a T50 horizon, segmenting remaining generated content into smaller units for rescoring.

10. The method of claim 9, wherein each of the pre-handoff trust packet and the post-handoff trust packet comprises at least a trust value, a ceiling flag, a module-activation indicator, and a cryptographic digest.

11. The method of claim 9, wherein the configured portion of the T50 horizon is eighty percent of the T50 horizon.

12. The method of claim 9, further comprising rescoring each segmented unit independently and reducing or blocking export of at least one segmented unit that fails a release policy.

13. The method of claim 9, further comprising recording the pre-handoff trust packet, the post-handoff trust packet, the trust delta, and a governance action in an Echo-Loop record.

14. The method of claim 9, further comprising applying a first trust penalty when a token-compression ratio exceeds a threshold across consecutive output windows and applying a second trust penalty when a rolling mean trust value rises above a baseline by more than a threshold amount.

15. The method of claim 9, further comprising detecting at least one data-gap indicator associated with sparse records or under-documented operating environments, appending an uncertainty indicator to a trust packet, and reducing a trust value responsive to the data-gap indicator.

16. The method of claim 9, wherein each trust packet further comprises a downgrade code, a policy-profile identifier, and a human-review status indicator.

17. The method of claim 15, wherein detecting the at least one data-gap indicator comprises appending an XPAT_GAP flag to the trust packet and automatically reducing the trust value by a predefined penalty.

18. A computer-implemented method for enforcing semantic integrity of AI-generated content, the method comprising: identifying within an AI-generated output a phrase span containing a semantically sensitive construct; selecting, by a parsing engine, the phrase span to include a cue term and at least one context term associated with the cue term; canonicalizing the phrase span; generating a cryptographic digest of the canonicalized phrase span; comparing the cryptographic digest with a trusted-hash registry storing canonicalized phrase spans and associated semantic metadata; when a match is absent or ambiguous, automatically performing at least one mitigation action selected from downgrading a trust value associated with the AI-generated output, annotating the AI-generated output, suppressing or quarantining the AI-generated output, and escalating the AI-generated output for human review; creating a snapshot record that includes the trust value, a validation status, a model identifier, and the cryptographic digest; and blocking downstream export of the AI-generated output until release criteria associated with the snapshot record are satisfied.

19. The method of claim 18, wherein the semantically sensitive construct comprises a negation, denial, exclusion, refusal, or caveat.

20. The method of claim 18, wherein the phrase span further includes at least one subject term, object term, modifier, temporal qualifier, or jurisdictional qualifier selected using dependency parsing, co-reference resolution, or semantic role analysis.

21. The method of claim 18, further comprising enforcing a Glossary Lock and hashing responses to context-locking prompts generated at session initiation for use in subsequent semantic validation.

22. The method of claim 18, wherein the trusted-hash registry stores domain-specific canonical phrases and semantic metadata for legal, medical, financial, or regulatory contexts.

23. The method of claim 18, wherein the mitigation action places the AI-generated output into a dual-signoff quarantine queue before re-integration or release.

24. The method of claim 23, wherein release of the AI-generated output from quarantine requires approval by two authorized reviewers when the mitigation action places the AI-generated output into the dual-signoff quarantine queue. IFR/tamper-evident governance tree

25. A computer-implemented trust-governance system comprising: a hashing engine configured to generate a meta-integrity digest from trust-state data associated with an AI output; a ledger-anchor module configured to store the meta-integrity digest in a tamper-evident ledger; a policy-binding engine configured to suppress, label, or route the AI output when a governance threshold is breached; and an audit interface configured to expose a verification record associated with the meta-integrity digest.

26. The system of claim 25, wherein the verification record comprises a QR-readable identifier, a zero-knowledge proof, or both.

27. The system of claim 25, further comprising a risk-tier escalator configured to apply a stricter governance threshold for outputs classified as high risk.

28. The system of claim 25, further comprising a fiduciary alignment engine configured to compare the AI output with a reference policy representation and limit a resulting trust score when an alignment measure falls below a threshold, and a board-audit dashboard configured to record and hash an override that raises the resulting trust score above a trust ceiling.

29. The system of claim 25, wherein the verification record comprises a transaction identifier linked to a QR-readable artifact that resolves to a ledger entry associated with the meta-integrity digest.

30. The system of claim 25, wherein the zero-knowledge proof is generated to validate the meta-integrity digest without exposing protected prompt content or protected output content.

31. The system of claim 28, wherein the board-audit dashboard records an override only upon satisfaction of a predefined approval threshold and hashes the override together with an adjusted trust score and an output identifier.
